(19) United States
(12) Patent Application Publication
(10) Pub. No.: US 2018/0130078 A1
(43) Pub. Date: May 10, 2018

(54) SYSTEMS AND METHODS OF CONTROLLING THE DISTRIBUTION OF PRODUCTS IN RETAIL SHOPPING FACILITIES

(71) Applicant: Wal-Mart Stores, Inc., Bentonville, AR (US)

(72) Inventors: Matthew A. Jones, Bentonville, AR (US); Nicholaus A. Jones, Fayetteville, AR (US)

(21) Appl. No.: 15/803,343

(22) Filed: Nov. 3, 2017

Related U.S. Application Data
(60) Provisional application No. 62/417,527, filed on Nov. 4, 2016.

(51) Int. Cl. G06Q 30/02; G06Q 10/08; G06Q 30/06

(52) U.S. Cl. CPC G06Q 30/0205; G06Q 30/0639; G06Q 10/087

(57) ABSTRACT

In some embodiments, a system comprises: a point of sales system comprising multiple point of sale devices at a retail store; and an inventory control circuit configured to: identify, from an aggregate of customer monitoring data of customers passing through a first area within a customer travel area, that a threshold number of the customers had a dwell time in the first area of at least a threshold dwell time; identify a first set of products positioned adjacent the first area; evaluate correlated sales data of each product of the first set and identify that a sales trend over time has a predefined relationship with at least a first trend threshold corresponding to the first product; and identify a first action to be performed relative to the first product as a function of the sales trend relative to the sales data of the first product.

### CROSS-REFERENCE TO RELATED APPLICATION

This application claims the benefit of U.S. Provisional Application No. 62/417,527, filed Nov. 4, 2016, which is incorporated herein by reference in its entirety.

### TECHNICAL FIELD

This invention relates generally to distributing products in retail stores.

### BACKGROUND

Customer loyalty can be critical to retail stores success. Through customer loyalty a retail facility can achieve repeat visits and purchases by customers. Further, improving access to products can have a significant effect on customer satisfaction. There is a need to improve customer experiences at retail stores.

### BRIEF DESCRIPTION OF THE DRAWINGS

Disclosed herein are embodiments of systems, apparatuses and methods to distributing products in retail stores. This description includes drawings, wherein:

FIG. 1 illustrates a simplified block diagram of an exemplary inventory management system, in accordance with some embodiments.

FIG. 2 illustrates a simplified block diagram, overhead view of an exemplary shopping facility, in accordance with some embodiments.

FIG. 3 illustrates an exemplary system for use in implementing methods, techniques, devices, apparatuses, systems, servers, sources and in managing inventory at one or more retail shopping facilities, in accordance with some embodiments.

FIG. 4 illustrates a simplified flow diagram of an exemplary process of tracking inventory and/or adjusting inventory based on aggregate customer dwell times, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided to enhance customer service while improving product sales. In some embodiments, an inventory management system includes and/or is in communication with a point of sales system that has multiple point of sale devices at a retail store or shopping facility and that are configured to track sales of products purchased at the shopping facility. The system further includes one or more inventory control circuits and memory communicatively coupled with the one or more inventory control circuits. Customer monitoring data can be collected over time based on sensor data that includes and/or can be used to determine at least dwell time information corresponding to customers at areas or locations distributed through at least a sales floor of the shopping facility. The inventory control system accesses the aggregate customer monitoring data corresponding to a plurality of different customers passing through different areas within customer travel areas of the shopping facility. From the aggregate customer monitoring data, the inventory control system can identify that a threshold number of the customers have a dwell time while in a first area that is at least a threshold dwell time. A set of one or more products positioned adjacent the first area can be identified. Correlated sales data can be evaluated for each of the set of products to determine whether and/or when there is a sales trend over time, relative to the sales data of a first product of the set of products, that has a predefined relationship with at least a trend threshold corresponding to the product. One or more actions to be performed relative to the product can be identified as a function of the sales trend relative to the sales data of the product.

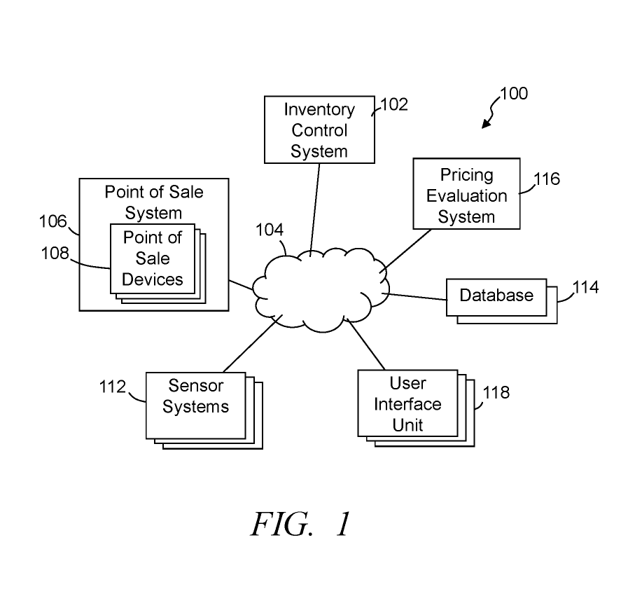

FIG. 1 illustrates a simplified block diagram of an exemplary inventory management system 100, in accordance with some embodiments. The system includes an inventory control system 102 communicatively coupled via one or more computer and/or communication networks 104 (e.g., wide area network (WAN), local area network (LAN), Internet, cellular, etc.) with at least one point of sale (POS) system 106 associated with at least one retail store or other such shopping facility. The point of sale system typically includes multiple point of sale devices 108, such as but not limited to registers, bar code scanners, radio frequency identifier (RFID) tag readers, credit card payment machines, other such devices, and typically a combination of two or more of such devices. Further, the point of sale devices may be operated by workers at a shopping facility, and in some instances, one or more point of sale devices may be operated by customers.

The inventory management system 100 further includes multiple sensor systems 112 distributed through at least one shopping facility, and/or receives sensor data from one or more sensor systems distributed through a shopping facility. The sensors provide sensor data that can be used to detect customers, determine dwell times, track customer movement through the shopping facility, obtain other such information, or a combination of two or more of such data. For example, some sensor systems may include bar code readers, RFID tag readers (e.g., reading tags on shopping carts, baskets, carried by customers, etc.), wireless network access point detection, wireless communication triangulation systems, distance measurement systems, light sensor systems (e.g., Bytelight systems by Acuity Brands Lighting, Inc.), cameras and image and/or video processing systems, communications from one or more user interface units (e.g., products searches over the Internet, pricing comparisons, etc.), other such sensor systems, and typically a combination of two or more of such systems. Other sensor data may be provided by other sources, such as GPS data from user interface units 118, inertial sensor data from a user interface units, steps or other movement tracking data, data from wireless access nodes, and/or other such sources.

Further, the inventory management system includes and/or is communicatively coupled with one or more databases 114. The one or more databases can include one or more product databases comprising product identifiers for each of the thousands of different products offered for sale through the one or more retail stores; item location database maintaining location information of items on the sales floor and/or at the retail store of the thousands of products; inventory count database tracking numbers of items of different products offered for sale at the one or more retail stores; customer monitoring database that maintains sensor data, historic data, and the like; sales database maintaining information about sales and/or historic sales data, which may include sales rates relative to location of products, sales trend data, other such sales information, or combination of two or more of such sales information; competitor databases maintaining information regarding competitors' products, pricing, and other such information; other such databases; and typically a combination of two or more of such databases. The databases may be maintained through a single system (e.g., server), or distributed over multiple different memory systems, which may be distributed over one or more locations.

The inventory control system 102 may include and/or be in communication with one or more pricing evaluation systems 116, which are configured to evaluate pricing of products at one or more shopping facility. The pricing evaluation may be based on location, customers purchasing, rate of purchasing, changes in rates of purchasing, cost relative to competitors, and/or others such evaluations. In some embodiments, the inventory management system further includes one or more user interface units 118 and/or is in communication with one or more user interface units. The user interface units can be mobile electronic devices (e.g., smartphones, tablets, cellular phones, smart watches, customer shopping facility electronic devices (e.g., scanner devices), and/or other such devices). The user interface units 118 may be carried by workers of the shopping facility and/or the customers. The user interface units may be configured to communicate information to the inventory control system 102. In some instances, the user interface units are configured to implement a software application (APP) that tracks at least some types of information and can communicate parts of or all of such information. For example, an APP may identify when a customer accesses competitors' pricing information and can communicate that information to the inventory control system. Similarly, the APP may provide location information to the inventory control system and/or timing information relative to the location information, which may be used to track customers dwell times through different areas of the shopping facility.

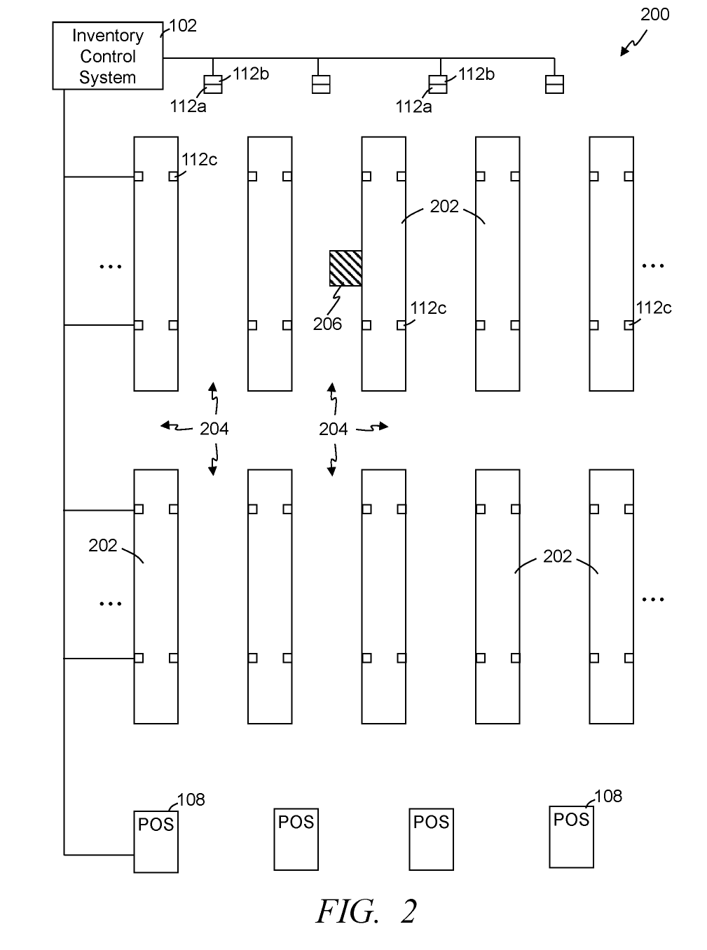

FIG. 2 illustrates a simplified block diagram, overhead view of an exemplary shopping facility 200, in accordance with some embodiments. The shopping facilities may, in some instances, be a retail sales facility, a fulfillment center, or other type of facility, and position numerous products throughout a sales floor that are to be sold and/or distributed to customers. The facility may be any size or format, and may include products from one or more merchants. For example, a facility may be a single store operated by one merchant, a chain of two or more stores operated by one entity, or may be a collection of stores covering multiple merchants. The shopping facility includes multiple product support device 202, such as but not limited to modular shelves, fixed shelving units, display racks, bins, carts, and/or other such product support devices to support products that are distributed through the shopping facility and upon which products are mounted or supported for display and retrieval by customers moving through the shopping facility. Further, the product support devices are arranged to define customer travel areas 204 (e.g., aisles, walkways, etc.) along which the products are placed to be accessed by customers for purchase.

In some embodiments, multiple sensor systems 112 are positioned at multiple different locations in the shopping facility to detect customers, detect customer movement, detect lack of movement, track movement and/or other such sensor systems. As described above, the sensors can include cameras 112a (which may include or communicate with image processing systems), laser sensor systems 112b, 112c (e.g., measure distance, detect customer and/or shopping carts, etc.), RFID tag readers, bar code readers, other such sensors, or combination of different types of sensors. In some instances, for example, one or more laser sensor systems 112b may be positioned proximate the ends of one or more travel areas 204 to detect customers and/or carts while in the travel area and/or detect a relative distance to the customer and/or cart, which can be used to determine a customer's location along the travel area. One or more laser sensor systems 112c may, in some applications, be positioned along product support devices to similarly detect the location of customers along the travel areas. Some embodiments include one or more image and/or video cameras that can capture images and/or video that are processed by one or more image and/or video processing systems that can be used to identify customers, determine relative locations along the travel areas, identify lack of movement, and the like. Such sensor information can be used to determine customers' dwell times at areas along the travel areas 204. Some methods of determining a customer's dwell times in an area are known, and some embodiments may implement one or more of these methods.

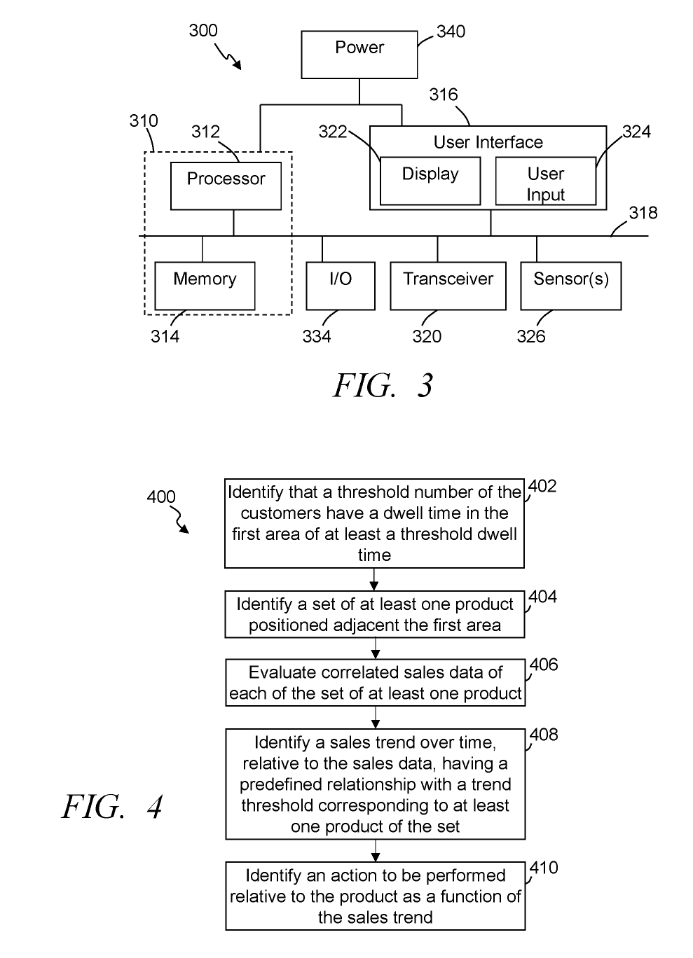

Further, the circuits, circuitry, systems, devices, processes, methods, techniques, functionality, services, servers, sources and the like described herein may be utilized, implemented and/or run on many different types of devices and/or systems. FIG. 3 illustrates an exemplary system 300 that may be used for implementing any of the components, circuits, circuitry, systems, functionality, apparatuses, processes, or devices of the inventory management system 100, and/or other above or below mentioned systems or devices, or parts of such circuits, circuitry, functionality, systems, apparatuses, processes, or devices. For example, the system 300 may be used to implement some or all of the inventory control system 102, the point of sale system 106, one or more sensor systems 112 or one or more portions of a sensor system, user interface units, pricing evaluation system, and/or other such components, circuitry, functionality and/or devices. However, the use of the system 300 or any portion thereof is certainly not required.

By way of example, the system 300 may comprise a control circuit or processor module 312, memory 314, and one or more communication links, paths, buses or the like 318. Some embodiments may include one or more user interfaces 316, and/or one or more internal and/or external power sources or supplies 340. The control circuit 312 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 312 can be part of control circuitry and/or a control system 310, which may be implemented through one or more processors with access to one or more memory 314 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 300 may be used to implement one or more of the above or below, or parts of, components, circuits, systems, processes and the like. For example, the system may implement the inventory control system 102 with the control circuit being an inventory control circuit, the point of sale system 106 with point of sale control circuits, one or more sensor systems 112 with sensor control circuits, or other components.

The user interface 316 can allow a user to interact with the system 300 and receive information through the system. In some instances, the user interface 316 includes a display 322 and/or one or more user inputs 324, such as buttons, touch screen, track ball, keyboard, mouse, etc., which can be part of or wired or wirelessly coupled with the system 300. Typically, the system 300 further includes one or more communication interfaces, ports, transceivers 320 and the like allowing the system 300 to communicate over a communication bus, a distributed computer and/or communication network 104 (e.g., a local area network (LAN), the Internet, wide area network (WAN), etc.), communication link 318, other networks or communication channels with other devices and/or other such communications or combination of two or more of such communication methods. Further the transceiver 320 can be configured for wired, wireless, optical, fiber optical cable, satellite, or other such communication configurations or combinations of two or more of such communications. Some embodiments include one or more input/output (I/O) ports 334 that allow one or more devices to couple with the system 300. The I/O ports can be substantially any relevant port or combinations of ports, such as but not limited to USB, Ethernet, or other such ports. The I/O interface 334 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 326 to provide information to the system and/or sensor information that is communicated to another component. As described above, sensors can include substantially any relevant sensor, such as distance measurement sensors (e.g., optical units, sound/ultrasound units, etc.), cameras and image and/or video processing systems, optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 300 comprises an example of a control and/or processor-based system with the control circuit 312. Again, the control circuit 312 can be implemented through one or more processors, controllers, central processing units, logic, software and the like. Further, in some implementations the control circuit 312 may provide multiprocessor functionality.

The memory 314, which can be accessed by the control circuit 312, typically includes one or more processor readable and/or computer readable media accessed by at least the control circuit 312, and can include volatile and/or nonvolatile media, such as RAM, ROM, EEPROM, flash memory and/or other memory technology. Further, the memory 314 is shown as internal to the control system 310; however, the memory 314 can be internal, external or a combination of internal and external memory. Similarly, some or all of the memory 314 can be internal, external or a combination of internal and external memory of the control circuit 312. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 104. The memory 314 can store code, software, executables, scripts, data, content, lists, programming, programs, log or history data, user information, customer information, product information, and the like. While FIG. 3 illustrates the various components being coupled together via a bus, it is understood that the various components may actually be coupled to the control circuit and/or one or more other components directly.

In some embodiments, the inventory management system 100 accesses and/or compiles customer monitoring data and/or aggregates of customer monitoring data that corresponding to the movement of multiple customers through the travel areas 204 of one or more shopping facilities. The monitoring data can include sensor data from one or more types of sensors at one or more locations in the relevant shopping facility. Further, the monitoring data is obtained over time providing the aggregate of data. Some embodiments utilize a sub-set or collection of sensor data to obtain an aggregate of customer monitoring data. The aggregate customer monitoring data may correspond to a particular area of a travel area, a set of areas of one or more travel areas, a period of time, a set of customers, other such criteria, or combination of two or more of such criteria. Further, the aggregate customer monitoring data may be a sub-set of customer monitoring data based on customer movement within one or more areas of one or more travel areas of the shopping facility. In some embodiments, the inventory control system identifies, from an aggregate of customer monitoring data corresponding to a plurality of different customers passing through a first area 206 within a customer travel area 204, that a threshold number of a plurality of different customers have a dwell time in the first area 206 of at least a threshold dwell time. Similarly, some embodiments identify the first area 206 within a customer travel area 204 where a threshold number of the plurality of different customers have a dwell time of at least the threshold dwell time. Further, the first area 206 may be identified based on sensor data, such as image processing, distance measurements, and/or other such sensor data, and the dwell times of the multiple different customers.

A set of at least one product can be identified that is positioned adjacent the first area 206. Some embodiments limit the products considered in the set by identifying products within a threshold distance of the customer and/or the first area. For example, a threshold distance may correspond to a predicted field of view based on the customers location and distance from the product support device (and potentially a direction the customer is looking based on pupal detection), a distance the customer is from the product support device times some multiplier (e.g., 1.5), a fixed threshold distance, a distance dependent on the height of the product support device, a distance dependent on the number of different products supported (e.g., shorter threshold distance when more products are supported), a distance dependent on the size of products and/or spacing between different products, other such factors, or combination of such factors. Typically, the inventory control system 102 and/or sensor data from one or more sensor systems 112, user interface units, and the like can identify which direction a customer is looking while within the first area 206 during the customer's dwell time. For example, image processing can identify a direction the customer is facing, an evaluation of sensor data can allow the system to determine a location of the customer relative to placement of products, sensor data may indicate a location of a cart relative to the customer's position, and/or other such methods allowing the system to determine a set of products that the customer is likely considering while at the first area 206. Similar sensor data can be evaluated for numerous different customers to identify when a threshold number of customers that each have dwell times of at least a threshold dwell time at the first area 206, and typically while generally facing the same direction and/or determined to be considering one or more of the same set of products.

The threshold number of customers can vary depending on one or more factors, such as but not limited to: one or more products of the set of products being considered, type or types of products of the set of products, the rate of sales of one or more products of the set of products, pricing of products, whether one or more products of the set of products is discounted, price per unit cost (e.g., price per measure of weight (e.g., grams, ounces, pounds, etc.), price per volume, price per unit of a quantity, etc.), the location within the shopping facility of the first area 206, a determined size of the first area, types of products adjacent to and/or within one or more threshold distances of the first area, based on statistical evaluations of dwell times (e.g., average dwell times, dwell times within one or more standard deviations of a median or average dwell time, other such statistical evaluations), time of day being considered, time of a week being considered, time of year being considered, and/or other such parameters. Similarly, the threshold dwell time may vary depending on one or more of the above factors and/or other factors, and the factors applied may be the same or different than the factors applied in setting and/or determining the threshold number of customers.

Some embodiments utilize a plurality of cameras 112a distributed through the shopping facility and each oriented to capture image data of an area of at least one customer travel area of the multiple customer travel areas on a sales floor. As described above, the multiple customer travel areas are typically proximate multiple different products offered for sale at the shopping facility. The system can include a product database that stores product identifiers for each of the thousands of different products, and in some instances further includes corresponding locations on the sales floor of those different products, and typically a location on a product support device 202. An image processing system can process the images and/or video to generate image data. The inventory control system 102 receives image data and identifies the set of at least one product. The identification of the set of products can, in some embodiments, be based at least in part on a threshold distance relationship between a location within the shopping facility of the first area 206 and location data of products defined with the product database.

The inventory control system further is configured to access sales data, such as through a sales data database, from the point of sale system 106, and/or one or more other sources. In some embodiments, the inventory control system 102 communicatively couples with the point of sales system and/or an inventory tracking system. The point of sale system 106 and/or the multiple point of sale devices 108 are configured to at least report, and in some instances track, product purchases at the shopping facility and/or communicate purchase information (e.g., product identifier information, quantities, size, weight, and/or other such information) to the inventory control system or other inventory tracking system that can track the sales of products and/or adjust inventory counts.

Some embodiments access the sales data to obtain sales data correlated to the one or more products of the identified set of products corresponding to an area where customers were dwelling. The correlated sales data of each product of the set of at least one product that were considered by the threshold number of customers is evaluated. In some embodiments, the inventory control system can determine when a sales trend over time, relative to the sales data of at least a first product of the set of products, has a predefined relationship with at least a trend threshold corresponding to the first product. The trend threshold can correspond to information over time relative to at least the first product. In some instances, the sales trend corresponds to a difference in sales that is detected relative to what is expected. The trend threshold typically is dependent on the product being considered and historic sales, historic sales trends, and/or inventory data associated with the product and/or sales trends. Further, the trend threshold may be adjusted based on one or more factors, such as but not limited to shopping facility wide changes in sales trends, sales trends of types of products, timing information (e.g., time of day, time of month, time of year, etc.), sales trends at other retail stores, sales trends of the same or related products at one or more different locations within the retail store and/or different retail stores, and/or other such factors.

Some representative examples of trends may include a trend of reduction in sales, a trend of an increase in sales, a trend in a reduction or increase in numbers of customers purchasing the first product, a change in sales rate, and other such trends. Further, some embodiments consider additional or alternative trends in setting the trend threshold and/or the type of trend considered, such as a trend of an increase or reduction in restocking of the first product, a trend of a reduction or increase in ordered replenishment of the first product, a trend in the number of customers considering the first product, a trend in the number of customers considering the first product in relation to a reduction in purchases of the first product, trends relative to different products at the different dwell time locations, trends relative to a same product at one or more different locations, other such trends, or combinations of two or more of such trends. In some embodiments, the inventory control system, in determining that the sales trend has the predefined relationship with at least a trend threshold, is configured to identify that a quantity of sales of the first product has changed by at least the trend threshold from a predicted sales quantity. The foregoing examples are intended to be illustrative and are not intended to convey an exhaustive listing of all possible trends. Instead, it will be understood that these teachings will accommodate any of a wide variety of trends and/or circumstances.

In some implementations, the inventory control system can identify that the first product is displayed at two different locations. Dwell times of customers can be considered at each of the different locations and corresponding sales data attributed to the different locations can be considered. Based on the evaluation, the inventory control system may attempt to identify one or more factors that can contribute to differences in sales and/or differences in trends associated with the different locations. Some embodiments may identify a sales trend by comparing sales of a first product, retrieved by customers adjacent an area 206 being considered, to sales of the first product retrieved by customers at a different location within the shopping facility.

The inventory control system 102 further identifies one or more actions to be performed relative to the first product relative to the sales data of the first product and/or as a function of the identified trend. The actions can include substantially any relevant action. For example, the action can include causing instructions to be communicated (e.g., via email, text message, printed, etc.) to a worker to stock additional products, confirm that a previous pick and/or restocking was performed, cause the pricing evaluation system to evaluate a price of the first product, cause the pricing evaluation system to determine pricing at one or more other sources for the product and/or competitors (e.g., accessing a competitors' web site), evaluating a placement of the first product, causing instructions to be issued directing the repositioning of the first product, cause the changing of the price of the first product, other such actions, or a combination of two or more actions.

In some embodiments, the inventory control system is configured to cause repositioning of multiple items of the first product that are located at an identified location of a product support device to a different second location on the product support device when the sales trend has the predefined relationship with the trend threshold. Further, in some applications the inventory control system evaluates inventory management data and identifies a previous task associated with the first product that was indicated as being performed. Based on the sales trend having the predefined relationship with the trend threshold, the inventory control system may determine that the previous task associated with the first product was not performed, and cause the previous task to be performed. A notification and/or report may be generated indicating the incompletion of the previous task. The notification may identify one or more workers previously responsible for the task and/or that indicated the task was completed, may indicate potential losses of sales, may indicate the detected trend, may indicate when the task was subsequently completed, and/or other such information. Additionally or alternatively, the inventory control system may direct, as at least part of an action, a worker to audit a quantity of the first product adjacent the first area 206 to confirm that a previous task was or was not performed.

The inventory control system can direct, as at least part of an action, an evaluation of competitor's pricing relative to the first product. Further, in causing an action to be implemented, the inventory control system may identify when pricing of the first product by the at least one competitor is a threshold difference from a pricing of the first product at the shopping facility, and cause a change in pricing of the first product at the shopping facility.

Other previous customer tracking systems identified individual customer's shopping and/or purchase behaviors. These previous tracking systems, however, fail to consider the aggregate of customers in identifying locations or areas 206 of a shopping facility where there may be issues. Further, these previous systems fail to correlate the sales data of products that are adjacent to an area where multiple customers repeatedly have dwell times that indicate consideration of products and/or attempts by customers to find products. In some embodiments the inventory management system 100 monitors the dwell times and locations of customers in the shopping facility and identifies amounts of time customers spend in a particular area 206 or location and uses this information to determine one or more actions to be taken. These actions may enhance customer experiences at the shopping facility, make it easier for customers to find products, improve sales of products, and the like. Sensor systems 112 (e.g., cameras, distance measurement devices, etc.) can be distributed throughout the shopping facility to provide sensor data to at least the inventory control system. Other sources may additionally or alternatively provide sensor data to the inventory control system 102, such as GPS data and/or inertial sensor data from a user interface unit, wireless network access points, and the like. The system can measure the amount of time that customers dwell in different areas throughout the shopping facility. Further, some embodiments determine customers' distances from the product support devices adjacent those areas where there is dwell time. Dwell times may indicate different conditions of products and/or factors being considered by customers, such as but not limited to a desired product being out of stock, a desired product being hard to find, a price tag missing, customer is price checking a competitor's site, customer is evaluating an alternative product, customer is confirming a shopping list or instructions, and/or other such factors.

Based on aggregate data of multiple different customers, the system can identify when a threshold number of customers dwell at an identified area 206 for at least a threshold period of time, which can be interpreted as a condition to investigate and/or in which one or more actions should be initiated. One or more products adjacent the area can be identified and evaluated relative to one or more parameters, such as the dwell times of the multiple customers, one or more statistical evaluations of the dwell times and/or number of customers, statistical evaluation of products that are within threshold distances of the area, and/or other such evaluations. The evaluation may determine that one or more actions should or should not be implemented. For example, the system can alert a worker to investigate issues with a particular product support device 202 based upon trends in the dwell time data. Some embodiments may further receive sensor data allowing the inventory control system to determine when the customer places a product in their shopping cart.

In some embodiments, the inventory control system further receives additional information (e.g., additional sensor data, feedback from a worker based on one or more actions, subsequent sales data following one or more actions take, etc.) after performing an evaluation. For example, the inventory control system may receive data from a worker, following an investigation of a product support device 202 by a working, indicating there were no apparent problems with the products, quantities of the product, etc. Based on the additional data the system may not take subsequent actions or may take further actions, such as flagging one or more products proximate the area 206 and cause a worker and/or the pricing evaluation system to investigate competing prices.

FIG. 4 illustrates a simplified flow diagram of an exemplary process 400 of tracking inventory and/or adjusting inventory based on aggregate customer dwell times, in accordance with some embodiments. In step 402, the inventory control system can identify, from an aggregate of customer monitoring data corresponding to a plurality of different customers passing through a first area 206 within a first customer travel area 204, that a threshold number of the plurality of different customers have a dwell time in the first area of at least a threshold dwell time. In step 404, a set of at least one product positioned adjacent the first area can be identified.

In step 406, correlated sales data of each of the set of at least one product is evaluated. In step 408, the system can identify a sales trend over time, relative to the sales data of at least a product of the set of at least one product, having a predefined relationship with at least a trend threshold corresponding to that product. In step 410, one or more actions can be identified that are to be performed relative to the product as a function of the sales trend relative to the sales data of the product.

Some embodiments comparing sales of a product retrieved by customers adjacent a first area to sales of the same product retrieved by customers at a different location within the shopping facility in identifying a sales trend. The inventory control system may, in determining that the sales trend has the predefined relationship with at least the trend threshold, identify that a quantity of sales of the product has changed by at least the trend threshold from a predicted sales quantity.

In some embodiments, image data is received from a plurality of cameras distributed through the shopping facility and each oriented to capture image data of an area of at least one customer travel area of multiple customer travel areas 204 on a sales floor. As described above, many of the customer travel areas are proximate multiple different products offered for sale at the shopping facility. The identification of the set of one or more products can include identifying the set of at least one product based on a threshold distance relationship between a location within the shopping facility of the first area 206 and location data of products defined with a product database.

One or more actions may be directed by the inventory control system. In some embodiments, the action can cause product movement on one or more product support devices 202 based changes in sales, sales rates that are less than expected, and the like. The identification of an action to be performed can include identifying that a product is to be moved, and cause repositioning of multiple items of the product that are located at a first location of a product support device to a different second location on the product support device when the sales trend has the predefined relationship with the trend threshold. Some embodiments evaluate inventory management data and identify a previous task associated with a particular product that was indicated as being performed. Based on the sales trend having the predefined relationship with the trend threshold, the inventory control system may identify that the previous task associated with the product was not performed, and can cause the previous task to be performed. For example, the inventory control system may notify a supervisor that the task was not performed, direct one or more workers to perform the task (e.g., email, text message, audio instructions, etc.). Similarly, an action may direct a worker to audit a quantity of a product adjacent the first area 206 to determine and/or confirm that the previous task was or was not performed.

In some embodiments, the system may direct, as an action, an evaluation of competitors relative to the one or more products. This may include accessing Internet sites, checking pricing, checking available quantities, determining whether a product is available locally, determine whether a product can be delivered, determine a duration of delivery, and/or other such evaluations of competitors. Further, some embodiments identify when pricing of the product by the at least one competitor is a threshold difference from a pricing of the product at the shopping facility, and cause a change in pricing of the product at the shopping facility.

Some embodiments provide systems and apparatus that provide inventory management. In some embodiments, a system comprises: a point of sales system comprising multiple point of sale devices at a shopping facility and configured to track sales of products purchased at the shopping facility; and an inventory control circuit communicatively coupled with the point of sales system and memory store code executed by the inventory control circuit, wherein the inventory control circuit is configured to: identify, from an aggregate of customer monitoring data corresponding to a plurality of different customers passing through a first area within a first customer travel area, that a threshold number of the plurality of different customers had a dwell time in the first area of at least a threshold dwell time; identify a first set of at least one product positioned adjacent the first area; evaluate correlated sales data of each product of the first set of at least one product and identify that a sales trend over time, relative to the sales data of a first product of the first set of at least one product, has a predefined relationship with at least a first trend threshold corresponding to the first product; and identify a first action to be performed relative to the first product as a function of the sales trend relative to the sales data of the first product.

Further, some embodiments provide methods of managing inventory at a shopping facility, comprising: by an inventory control circuit: identifying, from an aggregate of customer monitoring data corresponding to a plurality of different customers passing through a first area within a first customer travel area, that a threshold number of the plurality of different customers have a dwell time in the first area of at least a threshold dwell time; identifying a first set of at least one product positioned adjacent the first area; evaluating correlated sales data of each of the first set of at least one product; identifying a sales trend over time, relative to the sales data of a first product of the first set of at least one product, having a predefined relationship with at least a first trend threshold corresponding to the first product; and identifying a first action to be performed relative to the first product as a function of the sales trend relative to the sales data of the first product.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail store inventory management system, comprising:
a point of sales system comprising multiple point of sale devices at a retail store and configured to track sales of products purchased at the retail store;
a plurality of sensor systems distributed throughout the retail store; and
an inventory control circuit communicatively coupled with the point of sales system, the plurality of sensor systems, and memory storing code executed by the inventory control circuit, wherein the inventory control circuit is configured to:
receive, based on sensor data from a set of at least one sensor of the plurality of sensors, customer monitoring data representative of locations of customers within the retail store as the customers move through the retail store;
identify, from an aggregate of the customer monitoring data corresponding to a plurality of different customers passing through a first area within a first customer travel area, that a threshold number of the plurality of different customers had a dwell time in the first area of at least a threshold dwell time;
identify a first set of at least one product positioned adjacent the first area;
evaluate correlated sales data of each product of the first set of at least one product and identify that a sales trend over time, relative to the sales data of a first product of the first set of at least one product, has a predefined relationship with at least a first trend threshold corresponding to the first product; and
identify a first action to be performed relative to the first product as a function of the sales trend relative to the sales data of the first product.

2. The system of claim 1, wherein the plurality of sensor systems comprise a plurality of cameras distributed through the retail store and each oriented to capture image data of an area of at least one customer travel area of multiple customer travel areas on a sales floor wherein each of the multiple customer travel areas are proximate multiple different products offered for sale at the retail store; and
a product database comprising product identifiers for each of the multiple different products and corresponding locations on the sales floor;
wherein the inventory control system is configured to receive the image data and is communicatively coupled with the product database and in identifying the first set of at least the one product configured to identify the first set of at least one product based on a threshold distance relationship between a location within the retail store of the first area and location data of products defined with the product database.

3. The system of claim 1, wherein the inventory control circuit is configured to cause repositioning of multiple items of the first product that are located at a first location of a product support device to a different second location on the product support device when the sales trend has the predefined relationship with the first trend threshold.

4. The system of claim 1, wherein the inventory control circuit is configured to:
evaluate inventory management data and identify a previous task associated with the first product that was indicated as being performed;
determine, based on the sales trend having the predefined relationship with the first trend threshold, that the previous task associated with the first product was not performed; and
cause the previous task to be performed.

5. The system of claim 4, wherein the inventory control circuit is configured to direct, as the first action, a worker to audit a quantity of the first product adjacent the first area to confirm that the previous task was not performed.

6. The system of claim 1, wherein the inventory control circuit is configured to direct, as the first action, an evaluation of competitors relative to the first product.

7. The system of claim 6, wherein the inventory control circuit is configured to identify when pricing of the first product by the at least one competitor is a threshold difference from a pricing of the first product at the retail store, and to cause a change in pricing of the first product at the retail store.

8. The system of claim 6, wherein the inventory control circuit, in identifying that the sales trend has the predefined relationship with at least the first trend threshold, is configured to identify that a quantity of sales of the first product has changed by at least the first trend threshold from a predicted sales quantity.

9. The system of claim 1, wherein the inventory control system in identifying the first sales trend is configured to compare sales of the first product retrieved by customers adjacent the first area to sales of the first product retrieved by customers at a different location within the retail store.

10. A method of managing inventory at a retail store, comprising:
by an inventory control circuit:
identifying, from an aggregate of customer monitoring data corresponding to a plurality of different customers passing through a first area within a first customer travel area, that a threshold number of the plurality of different customers have a dwell time in the first area of at least a threshold dwell time;
identifying a first set of at least one product positioned adjacent the first area;
evaluating correlated sales data of each of the first set of at least one product;
identifying a sales trend over time, relative to the sales data of a first product of the first set of at least one product, having a predefined relationship with at least a first trend threshold corresponding to the first product; and
identifying a first action to be performed relative to the first product as a function of the sales trend relative to the sales data of the first product.

11. The method of claim 10, further comprising:
receiving image data from a plurality of cameras distributed through the retail store and each oriented to capture image data of an area of at least one customer travel area of multiple customer travel areas on a sales floor wherein each of the multiple customer travel areas are proximate multiple different products offered for sale at the retail store; and
wherein the identifying the first set of at least one product comprises identifying the first set of at least one product based on a threshold distance relationship between a location within the retail store of the first area and location data of products defined with the product database.

12. The method of claim 10, wherein the identifying the first action to be performed comprises identifying that the first product is to be moved; and
causing repositioning of multiple items of the first product that are located at a first location of a product support device to a different second location on the product support device when the sales trend has the predefined relationship with the first trend threshold.

13. The method of claim 10, further comprising:
evaluating inventory management data and identifying a previous task associated with the first product that was indicated as being performed;
determining, based on the sales trend having the predefined relationship with the first trend threshold, that the previous task associated with the first product was not performed; and
causing the previous task to be performed.

14. The method of claim 13, further comprising:
directing, as the first action, a worker to audit a quantity of the first product adjacent the first area to confirm that the previous task was not performed.

15. The method of claim 10, further comprising:
directing, as the first action, an evaluation of competitors relative to the first product.

16. The method of claim 15, wherein directing the evaluation of the at least one competitor comprises identifying when pricing of the first product by the at least one competitor is a threshold difference from a pricing of the first product at the retail store; and
causing a change in pricing of the first product at the retail store.

17. The method of claim 15, wherein the determining that the sales trend has the predefined relationship with at least the first trend threshold comprises identifying that a quantity of sales of the first product has changed by at least the first trend threshold from a predicted sales quantity.

18. The method of claim 10, wherein the identifying the first sales trend comprises comparing sales of the first product retrieved by customers adjacent the first area to sales of the first product retrieved by customers at a different location within the retail store.
